(19) United States
(12) Patent Application Publication
(10) Pub. No.: US 2025/0203018 A1
(43) Pub. Date: Jun. 19, 2025

(54) PRINTING SYSTEM, PRINTER, COLORIMETER, COLOR MATERIAL STABILIZATION DETERMINATION METHOD, AND PROGRAM

(71) Applicant: KONICA MINOLTA, INC., Tokyo (JP)

(72) Inventor: Keishi Sakuma, Tokyo (JP)

(73) Assignee: KONICA MINOLTA, INC., Tokyo (JP)

(21) Appl. No.: 18/971,485

(22) Filed: Dec. 6, 2024

(30) Foreign Application Priority Data
Dec. 13, 2023 (JP) 2023-210589

(51) Int. Cl. H04N 1/00; B41J 2/21; B41J 3/46

(52) U.S. Cl. CPC H04N 1/00034; B41J 2/2107; B41J 3/46; H04N 1/00055; H04N 1/00074; H04N 1/00323; H04N 1/00045

(57) ABSTRACT

A printing system includes: a printer that prints an arbitrary printed product on a printing medium; and a colorimeter that measures a color of the printed product, in which the printer includes a printing part, and a colorimetry controller that causes the printing part to print, based on information on the printed product, a measurement patch to be used for measurement of stabilization of a color material of the printed product and the printed product on the printing medium, and the colorimeter includes a colorimetry part, and a colorimetry controller that causes the colorimetry part to measure the color of the measurement patch and determines, based on an amount of change in the color of the measurement patch, whether the color material of the printed product has been stabilized.

### CROSS-REFERENCE TO RELATED APPLICATIONS

The entire disclosure of Japanese patent Application No. 2023-210589, filed on Dec. 13, 2023, is incorporated herein by reference in its entirety.

### BACKGROUND OF THE INVENTION

### Technical Field

The present invention relates to a printing system, a printer, a colorimeter, a color material stabilization determination method, and a program.

### Description of Related Art

In a printing system, a waiting time occurs until a color material (ink) of a printed product printed on a printing medium is dried and the color is stabilized. If printing is newly performed on the printing medium or the printing media are arranged to overlap each other before the color material is stabilized, the printing medium may be contaminated.

Therefore, conventionally, an elapsed time from printing until the color material is stabilized is managed, and it is waited until a time at which the color material is considered to be stabilized. For example, in relation to this type of technology, there is a technology described in JP2007-259203A. In JP2007-259203A, a technology is described in which, with a predetermined color material (ink) and under predetermined environmental conditions, a change in the color of the color material is measured by a colorimeter through prior verification, and a stabilization time required for the color of the color material to stabilize is determined. In the conventional technology described in JP2007-259203A, colorimetry is performed at the time of printing after a stabilization time determined by preliminary verification has elapsed.

The conventional technology described in JP2007-259203A performs colorimetry on all printed products after a uniform stabilization time determined by preliminary verification has elapsed, without considering the difference in printing content or printing conditions of print jobs. However, the stabilization time of the color material (ink) varies depending on the print content and print conditions of a print job. Therefore, the conventional technology described in JP2007-259203A repeats color measurement of a color material and standby for stabilizing the color material depending on the color material. As a result, the conventional technique described in JP2007-259203A has a problem in that a waiting time longer than necessary occurs in some printing operations.

In addition, for example, there is an ink jet machine which uses UV ink (ultraviolet curable ink) as a color material. The UV ink contains a component called a photopolymerization initiator that cures the ink by irradiation with UV (ultraviolet rays). The photopolymerization initiator has a characteristic that it develops a phenomenon of changing to yellow (yellowing) by UV irradiation, and then the yellow component fades with the passage of time. It takes a particularly long time for a color material such as UV ink containing such a photopolymerization initiator to be stabilized in color after printing. When colorimetry is performed on such a color material, there is a possibility that an accurate colorimetric value cannot be obtained. Therefore, there is a possibility that an erroneous stabilization time is determined and a waiting time longer than necessary is generated.

### SUMMARY OF THE INVENTION

The present invention has been made in consideration of the above-described problems of the conventional art. An advantage of some aspects of the invention is to provide a printing system, a printer, a colorimeter, a color material stabilization determination method, and a program for determining whether a color material of a printed product is stabilized in a short time without being affected by a difference in content of the printed product or a printing condition.

To achieve at least one of the abovementioned objects, according to an aspect of the present invention, a printing system reflecting one aspect of the present invention comprises: a printer that prints an arbitrary printed product on a printing medium; and a colorimeter that measures a color of the printed product, in which the printer includes a printing part, and a printing controller that causes the printing part to print, based on information of the printed product, a measurement patch to be used for measurement of stabilization of a color material of the printed product and the printed product on the printing medium, and the colorimeter includes a color measuring part, and a colorimetry controller that causes the color measuring part to measure the color of the measurement patch and determines, based on an amount of change in the color of the measurement patch, whether the color material of the printed product has been stabilized.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram of an overall configuration of a printing system according to an embodiment.

FIG. 2 is a block diagram of the printing system according to the embodiment.

FIG. 3 is a configuration view of a color chart image.

FIG. 4A is a control sequence diagram (1) of the printing system according to the embodiment.

FIG. 4B is a control sequence diagram (2) of the printing system according to the embodiment.

FIG. 5 is an explanatory diagram of a yellow component change amount of a measurement patch.

FIG. 6 is an explanatory diagram for generation of a measurement patch in which colorimetry points are specified.

FIG. 7 is a flowchart showing colorimetry control of the printing system according to the embodiment.

FIG. 8 is a configuration diagram of a color chart image used at the time of periodic detection.

FIG. 9 is an explanatory diagram of a method of predicting a stabilization completion time of a color material (ink).

### DETAILED DESCRIPTION

According to the present invention, it is possible to determine in a short time whether a color material of a printed material has been stabilized, without being influenced by differences in the content of the printed material or printing conditions.

Hereinafter, one or more embodiments of the present invention will be described with reference to the drawings. However, the scope of the invention is not limited to the disclosed embodiments.

### <Configuration of Printing System>

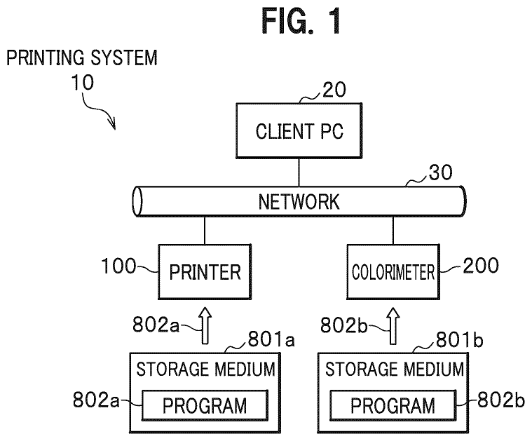

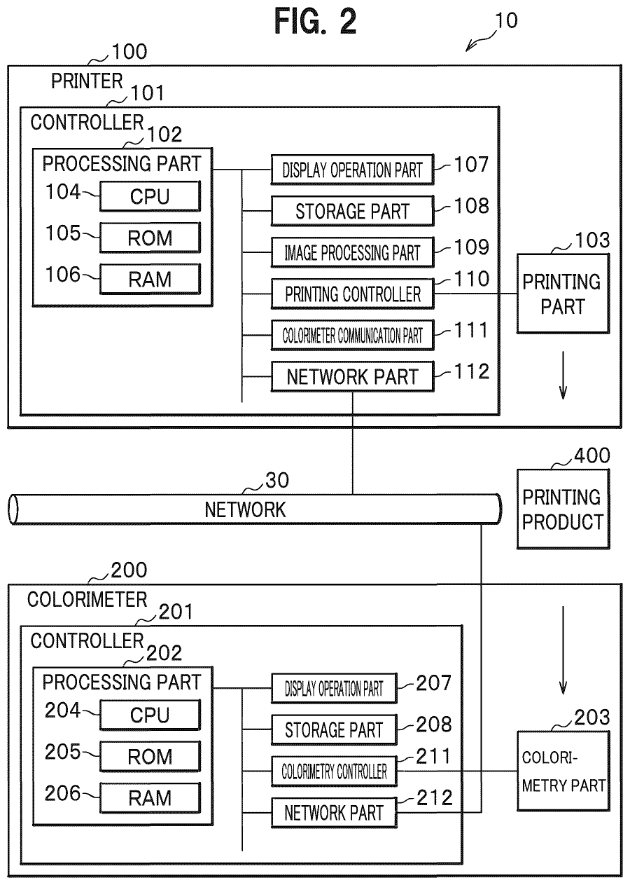

Hereinafter, a configuration of a printing system 10 according to an embodiment of the present invention will be described with reference to FIGS. 1 and 2. FIG. 1 is a diagram of an overall configuration of the printing system 10 according to the present embodiment. FIG. 2 is a block diagram of the printing system 10.

As shown in FIG. 1, the printing system 10 according to the present embodiment includes a client PC 20, a network 30, a printer 100, and a colorimeter 200. The client PC 20 is operated by a user. The network 30 communicably connects the apparatuses/devices. The printer 100 prints a printed product on a printing medium. The colorimeter 200 measures the color (color development) of a color material used in a printed product.

A program 802a stored in a storage medium 801a is installed in the printer 100, thereby constructing the components in the controller 101 shown in FIG. 2. Furthermore, a program 802b stored in a storage medium 801b is installed in the colorimeter 200, thereby constructing the components in the controller 201 shown in FIG. 2.

As shown in FIG. 2, the printer 100 includes a controller (or control device) 101 that controls the operation of the entire printer 100 and a printing part 103 that comprises hardware components for printing and performs the printing. The controller 101 includes a processing part (or hardware processor) 102 including a central processing unit (CPU) 104, read-only memory (ROM) 105, and random-access memory (RAM) 106, a display operation part (or I/O device) 107, a storage part (or storage) 108, an image processing part (or image processing device) 109, a printing controller 110, a colorimeter communication part (or colorimeter communication interface) 111, and a network part (or network interface) 112. The printing part 103, the image processing part 109, and the print controller 110 may comprise a central processing unit (CPU) and/or may be controlled or implemented by functions of the CPU 104.

The processing part 102 executes various kinds of arithmetic processing. The display operation part 107 displays various kinds of information and receives a user operation. The storage part 108 stores various kinds of information. The image processing part 109 executes image processing. The printing controller 110 causes the printing part 103 to perform printing. The colorimeter communication part 111 communicates with the colorimeter 200. The network part 112 is connected to the network 30.

The controller 101 temporarily holds print job data in the storage part 108. The controller 101 receives a print start request for the print job stored in the storage part 108 in response to an instruction from an external device connected via the network part 112 and the network 30 or a user operation on the display operation part 107. Then, in the controller 101, the image processor 109 generates print image data based on the print job data. Then, the printing controller 110 transmits the print image data to the printing part 103, and controls the printing part 103 to cause the printing part 103 to print the print image data.

The colorimeter 200 includes a controller (or control device) 201 which controls the overall operation of the colorimeter 200, and a colorimetry part 203 which comprises hardware components for colorimetry and measures a color of a color material used to print the printed product 400. The controller 201 includes a processing part (or hardware processor) 202 including a central processing unit (CPU) 204, read-only memory (ROM) 205, and random-access memory (RAM) 206, a display operation part (or I/O device) 207, a storage part (or storage) 208, a colorimetry controller 211, and a network part (or network interface) 212. The colorimetry part 203 and the colorimetry controller 211 may comprise a central processing unit (CPU) and/or may be controlled or implemented by functions of the CPU 204.

The processing part 202 executes various kinds of arithmetic processing. The display operation part 207 displays various kinds of information and receives a user operation. The storage part 208 stores various kinds of information. The colorimetry controller 211 causes the colorimetry part 203 to measure the color. The network part 212 is connected to the network 30.

The controller 201 receives a request to start colorimetry on a printed material by a user's operation on the display operation part 207. Then, in the controller 201, the colorimetry controller 211 controls the colorimetry part 203 to cause the colorimetry part 203 to measure a color of the printed material to be measured, and stores the color measurement result in the storage part 208.

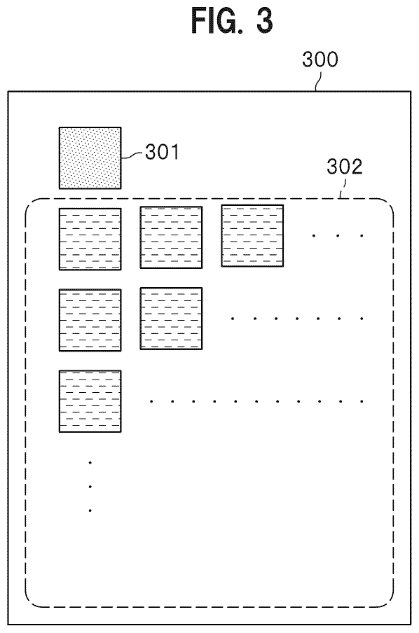

In the printing system 10, the printing controller 110 of the printer 100 causes the printing part 103 to print the measurement patch and the printed product on the printing medium based on the printing job data (information on the printed product). The measurement patch is an image used for measuring the stabilization of the color material of the printed product. Here, a description will be provided on the assumption that the printing controller 110 of the printer 100 causes the printing part 103 to print, for example, the color chart image 300 including the measurement patch 301 and the color patch 302 shown in FIG. 3. The color patch 302 is an image in a plurality of colors used for various inspections (evaluations).

FIG. 3 is a configuration diagram of the color chart image 300. In the example shown in FIG. 3, the color chart image 300 includes measurement patch 301 and color patches 302. In the description of the present embodiment, it is assumed that the measurement patch 301 and each of the color patches 302 have rectangular (preferably, square) shapes. The measurement patch 301 and the color patches 302 are formed in an image peripheral portion (bleed portion) on the printing medium.

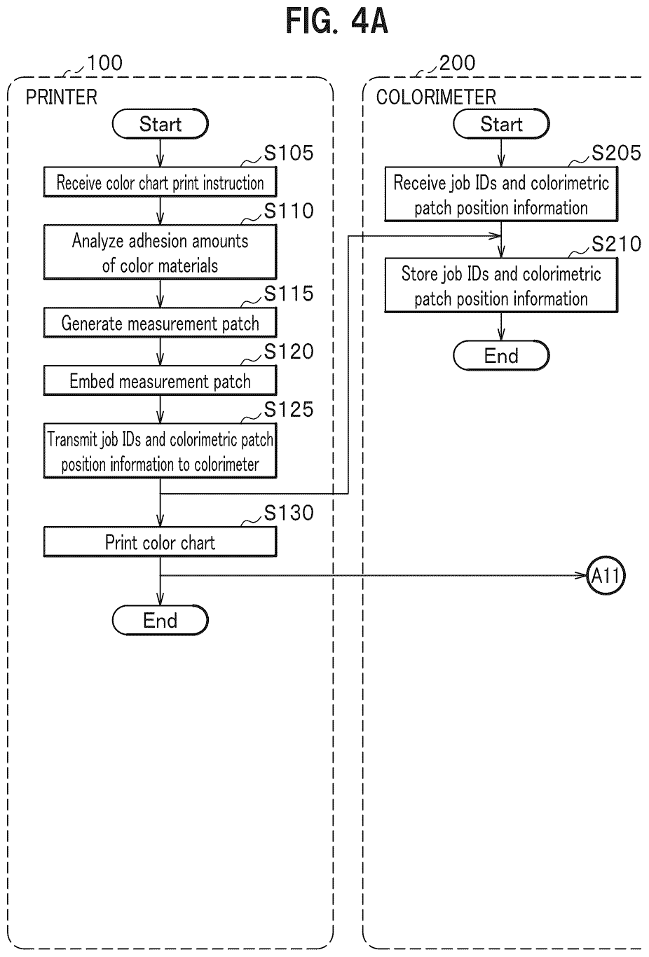

FIGS. 4A and 4B are control sequence diagrams of the printing system 10. Here, a case where the printer 100 prints the color chart image 300 (FIG. 3) and the colorimeter 200 performs colorimetry on the measurement patch 301 included in the color chart image 300 will be described.

In the example shown in FIG. 4A, first, the controller 101 of the printer 100 receives the job ID of the color chart image 300 and the print instruction from the user PC 20 by the processing part 102 (step S105). Next, the controller 101 causes the processing part 102 to analyze adhesion amounts of the color materials of the color chart image 300 (step S110).

After step S110, the controller 101 causes the image processor 109 to generate image data of the measurement patch 301 (step S115) and embed the image data of the measurement patch 301 in print image data of the color chart image 300 (step S120). At this time, the image processing part 109 generates colorimetric patch position information.

After step S120, the controller 101 causes the colorimeter communication part 111 to transmit the job ID and the colorimetric patch position information to the colorimeter 200 (step S125).

The controller 101 causes the printing controller 110 to cause the printing part 103 to print the color chart image 300 on a print medium (step S130). Thereafter, the printer 100 ends the series of processing shown in FIG. 4A.

After the above-described step S125, the controller 201 of the colorimeter 200 receives, by the processing part 202, the job ID and the colorimetric patch position information from the printer 100 (step S205). After step S205, the controller 201 causes the processing part 202 to store the received job ID and colorimetric patch position information in the storage part 208 (step S210).

As shown in FIG. 4B, after step S130, the user places (sets) the color chart image 300 (FIG. 3) on the colorimetry part 203 of the colorimeter 200 (step S305). The controller 201 of the colorimeter 200 causes the processing part 202 to display a list of the job IDs of the print jobs stored in the storage part 208 on the display operation part 207 (step S310).

The controller 201 causes the processing part 202 to receive a user selection of the job ID (step S315). The controller 201 causes the processing part 202 to acquire the measurement patch position information linked to (associated with) the job ID (step S320). The controller 201 causes the colorimetry controller 211 to cause the colorimetry part 203 to measure a color of the measurement patch 301 (step S325).

After step S325, the controller 201 causes the processing part 202 to calculate an amount of change in the color of the measurement patch 301 (step S330). Next, the controller 201 causes the processing part 202 to determine whether the amount of change is equal to or less than a threshold value (step S335). If it is determined in the determination of step S335 that the amount of change is not equal to or less than the threshold value (if “No”), the process returns to step S325. On the other hand, if it is determined in step S335 that the amount of change is equal to or less than the threshold value (if “Yes”), the colorimeter 200 determines that stabilization of the color materials has been completed (step S340).

After step S340, the controller 201 causes the colorimetry controller 211 to cause the colorimetry part 203 to measure colors of the color patches 302 (step S345).

After step S345, the controller 201 causes the processing part 202 to store the colorimetry results of the color patches 302 in the storage part 208 (step S350). Thereafter, the colorimeter 200 ends the series of processes shown in FIG. 4B.

Note that in a case where the result of the determination in step S335 is “No” for more than the arbitrary number of times, the colorimetry controller 211 may temporarily stop the colorimetry on the measurement patch 301. That is, when it is determined that the color material of the printed product 400 is not stabilized based on the amount of change in the color of the measurement patch 301, the colorimetry controller 211 may temporarily stop the colorimetry on the measurement patch 301.

Here, the control sequences shown in FIGS. 4A and 4B will be supplementarily described. When the colorimeter 200 performs colorimetry on the printed product 400 printed by the printer 100, the printer 100 generates print image data by the image processing part 109. Thereafter, data corresponding to the maximum amount of color material adhesion is identified with reference to all pixel data constituting the print image data within the same printed product 400.

The printer 100 generates image data of the measurement patch 301 with an amount of color material adhesion equivalent to the maximum amount of color material adhesion, and embeds the image data of the measurement patch 301 at a specific position in the print image data of the printed product 400. That is, in the printer 100, the printing controller 110 causes the printing part 103 to print the measurement patch 301 on the printing medium with the same amount as the maximum amount of color material adhesion within the same printed product 400.

The colorimeter communication part 111 transmits the position information on the measurement patch 301 and the ID information on the print job to the colorimeter 200 connected via the network 30 and the network part 112. Upon receiving the position information on the measurement patch 301 and the ID information on the print job, the colorimeter 200 stores them in the storage part 208 in association with each other.

Thereafter, the printing controller 110 causes the printing part 103 to print the print image data in which the measurement patches 301 are embedded as the printed product 400. The printed product 400 is transported to the colorimeter 200 by a user, and is placed (set) in the colorimetry part 203 of the colorimeter 200.

The controller 201 of the colorimeter 200 receives a colorimetry start request by a user's operation on the display operation part 207. Then, the controller 201 causes the processing part 202 to display the list of the job IDs of the print jobs stored in the storage part 208 on the display operation part 207. Then, the controller 201 causes the user to select a print job of which job ID is to be subjected to colorimetry.

The controller 201 causes the processing part 202 to read, from the storage part 208, the measurement patch position information associated with the job ID selected by the user. Then, the controller 201 causes the colorimetry controller 211 to cause the colorimetry part 203 to measure the color of the measurement patch 301 based on the measurement patch position information, and stores the colorimetry result in the storage part 208.

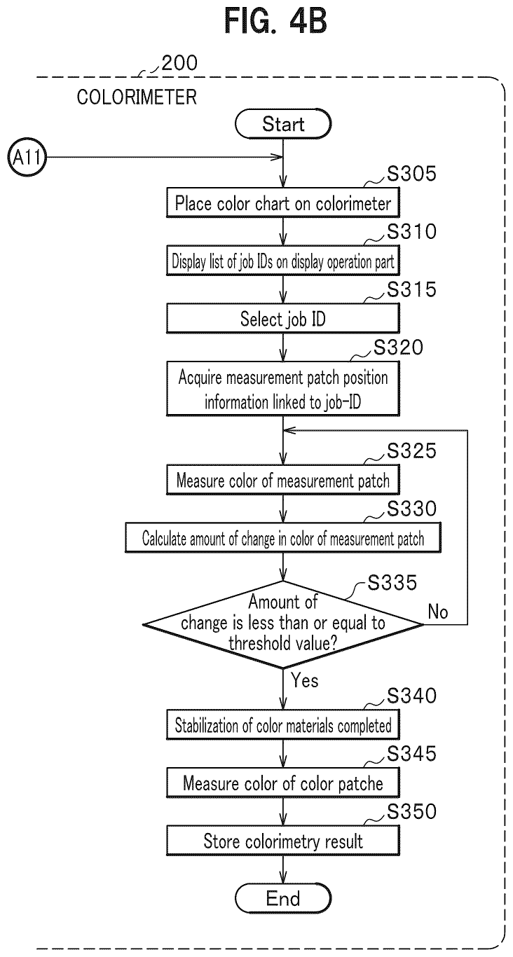

Next, the controller 201 causes the processing part 202 or the colorimetry controller 211 to calculate a change rate of color measurement results based on color measurement results of the measurement patch 301 for the plurality of times stored in the storage part 208. When the change rate is equal to or less than a predetermined threshold value 703 (FIG. 5), the processing part 202 or the colorimetry controller 211 determines that the stabilization of the color material is completed. Then, the colorimetry controller 211 starts colorimetry on the entire printed product 400.

Here, with reference to FIG. 5, the method of determining stabilization of the color material performed based on the amount of change in color in a case where the color of the measurement patch 301 is measured will be described. Here, as an example, a case where the printer 100 uses UV ink (ultraviolet curable ink) will be described. FIG. 5 is an explanatory diagram of a yellow component change amount of the measurement patch 301. FIG. 5 shows that the yellow component of the measurement patch 301 fades and decreases with the lapse time from the completion of printing, and then the yellow component of the measurement patch 301 decreases below the predetermined threshold value 703 arbitrarily determined.

The UV ink (ultraviolet curable ink) contains a component called a photopolymerization initiator that cures the ink by irradiation with UV (ultraviolet rays). The photopolymerization initiator has a characteristic that it develops a phenomenon of changing to yellow (yellowing) by UV irradiation, and then the yellow component fades with the passage of time. It takes a particularly long time for a color material such as UV ink containing such a photopolymerization initiator to be stabilized in color after printing. The degree of yellowing and the time until the color is stabilized due to fading (stabilization time) vary depending on the adhesion amount (use amount) of the ink and the UV irradiation intensity. Therefore, the printer 100 using UV ink (ultraviolet curable ink) measures the color of the measurement patch 301 and determines the stabilization of the color material by confirming that the amount of change in the yellow component in a measurement coordinate space of the color of the measurement patch 301 has become the predetermined threshold value 703 or less.

The setting of the predetermined threshold value 703 is performed by causing the display operation part 207 of the colorimeter 200 to display a threshold setting screen (not shown) in advance. When the user inputs the predetermined threshold value 703 on the threshold setting screen, the controller 201 of the colorimeter 200 stores the input predetermined threshold value 703 in the storage part 208.

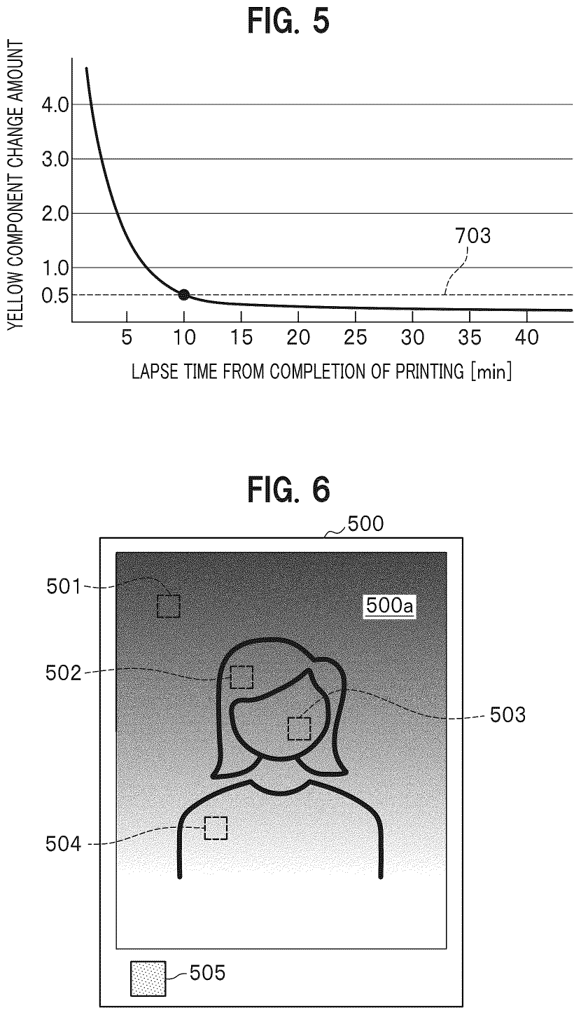

Here, with reference to FIG. 6, the generation of the measurement patch in which colorimetry points are specified will be described. FIG. 6 is an explanatory diagram for generation of a measurement patch 505 in which the colorimetry points are specified. In the example shown in FIG. 6, in a color chart image 500, first colorimetry point 501 to fourth colorimetry point 504 are arranged in a central portion 500a of the print image as color patches of arbitrary points, and the measurement patch 505 is arranged in a place deviated from the central portion 500a of the print image.

The controller 101 of the printer 100 causes the display operation part 107 to display a designation screen (not shown) on which a user can designate (set) a colorimetry point(s) for a print job image to be a colorimetry target(s). In the example shown in FIG. 6, the user designates (sets) the first colorimetry point 501, the second colorimetry point 502, the third colorimetry point 503, and the fourth colorimetry point 504 for the print job image. The controller 101 stores the position information on each colorimetry point in the storage part 108.

When generating the image data of the measurement patch 505, the image processing part 109 refers to all pixel data within a range designated by the first colorimetry point 501 to the fourth colorimetry point 504, and specifies data having the maximum amount of color material adhesion. The image processing part 109 then generates the image data of the measurement patch 505 with the same amount of color material adhesion as the maximum amount of color material adhesion. At that time, the image processing part 109 embeds the image data of the measurement patch 505 at the specific position of the print image data in the printed product 400.

Such a printing system 10 can further shorten a waiting time until color material stabilization by limiting a reference range for identifying the maximum value of the color material adhesion amount only to the range in which the color measurement is performed.

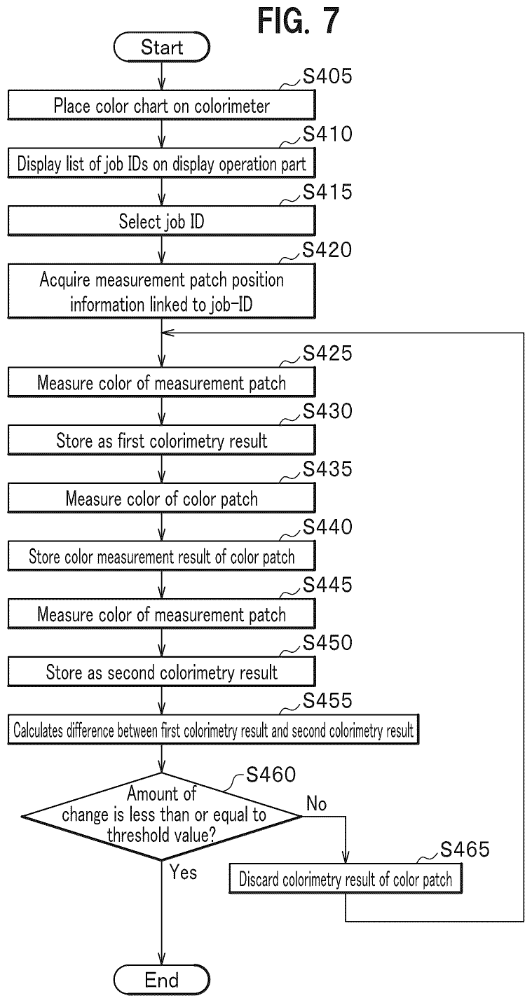

Here, a colorimetry control including processing of discarding the colorimetry result will be described with reference to FIG. 7. FIG. 7 is a flowchart showing the colorimetry control by the printing system 10. Here, a case where the printer 100 prints the color chart image 500 (FIG. 6) and the colorimeter 200 performs colorimetry on the measurement patch 301 included in the color chart image 500 will be described. FIG. 7 shows an example of processing that can be performed instead of the processing in FIG. 4B.

In the example shown in FIG. 7, the user places the color chart image 500 (FIG. 6) on the colorimetry part 203 of the colorimeter 200 (step S405). The controller 201 of the colorimeter 200 causes the processing part 202 to display the list of the job IDs of the print jobs stored in the storage part 208 on the display operation part 207 (step S410).

The controller 201 causes the processing part 202 to receive a user selection of the job ID (step S415). The controller 201 causes the processing part 202 to acquire the measurement patch position information linked to (associated with) the job ID (step S420). The controller 201 causes the colorimetry controller 211 to cause the colorimetry part 203 to measure a color of the measurement patch 505 (step S425). After step S425, the controller 201 causes the processing part 202 to store the colorimetry result of the measurement patch 505 as a first colorimetry result in the storage part 208 (step S430).

After step S430, the controller 201 causes the colorimetry controller 211 to cause the colorimetry part 203 to measure a color of a color patch at an arbitrary point (step S435). Here, the color patch is, for example, an image of an arbitrary point among the first colorimetry point 501 to the fourth colorimetry point 504. After step S445, the controller 201 causes the processing part 202 to store the color measurement result of the measured color patch in the storage part 208 (step S440).

After step S440, the controller 201 causes the colorimetry controller 211 to cause the colorimetry part 203 to measure the color of the measurement patch 505 (step S445). After step S445, the controller 201 causes the processing part 202 to store the colorimetry result of the measurement patch 505 as a second colorimetry result in the storage part 208 (step S450).

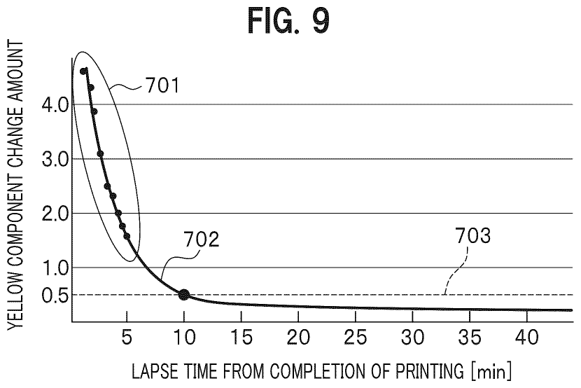

After step S450, the controller 201 calculates a difference between the first colorimetry result and the second colorimetry result by the processing part 202 (step S455). Next, the controller 201 causes the processing part 202 to determine whether the difference is equal to or less than the predetermined threshold value 703 (FIG. 9) (step S460). If the difference is equal to or less than the predetermined threshold value 703 (FIG. 9) (if “Yes”), the series of processing shown in FIG. 7 ends. On the other hand, if the difference is not equal to or less than the predetermined threshold value 703 (FIG. 9) (if “No”), the colorimetry result of the color patch subjected to colorimetry in step S435 is discarded (step S465). Here, the color patch is, for example, an image of an arbitrary point among the first colorimetry point 501 to the fourth colorimetry point 504. Thereafter, the processing returns to step S425.

In such a printing system 10, first, the colorimeter 200 performs colorimetry on the measurement patch 505 and stores a colorimetry result in the storage part 208 as a first colorimetry result. Next, the colorimeter 200 measures the color of the color patch at the arbitrary point and stores the color measurement result in the storage part 208. Next, the colorimeter 200 performs colorimetry on the measurement patch 505 again, and stores the colorimetry result in the storage part 208 as a second colorimetry result.

Then, the colorimeter 200 compares the first colorimetry result with the second colorimetry result, and calculates a color difference. If the calculation result is equal to or more than the predetermined threshold value 703, the colorimeter 200 determines that a color change has occurred during the colorimetry on the color patch of the color chart image 500, and discards the colorimetry result of the color patch. Such a printing system 10 can ensure acquisition of a colorimetry result in a state where the color material is stabilized.

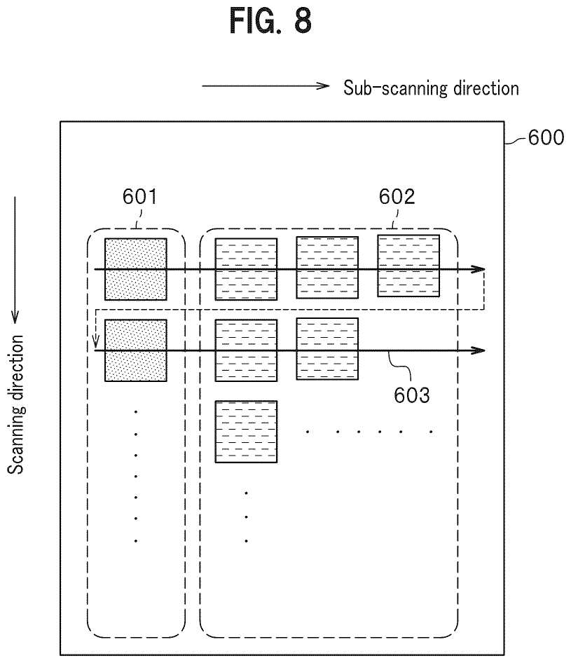

The above-described color chart images 300 and 500 can be modified into, for example, a color chart image 600 shown in FIG. 8. FIG. 8 is a configuration diagram of the color chart image 600 used at the time of periodic detection. In the example shown in FIG. 8, the color chart image 600 includes a plurality of measurement patches 601 and color patches 602.

As shown in FIG. 8, the measurement patches 601 are arranged in the color chart image 600. Then, the colorimeter 200 alternately and periodically executes colorimetry on the color patches 602 and colorimetry on the measurement patches 601 along a colorimetry order 603. As a result, the colorimeter 200 periodically acquires the amount of change in the color of the measurement patch 301, and sequentially monitors the difference in the colorimetry results of the measurement patch 601 periodically executed a plurality of times. Next, when the difference becomes equal to or more than the predetermined threshold value 703, the colorimeter 200 displays, on the display operation part 207, a warning message indicating that a change in the color of the color material has occurred, and immediately stops the colorimetry operation. Note that the case where the difference is equal to or more than the predetermined threshold value 703 means the case where it is determined that the color material of the printed product 400 is not stabilized. In this case, the colorimetry controller 211 causes the display device to display a warning message indicating that the color is not stabilized. The warning message nay be displayed on the display operation part 107 by the printing controller 110 of the printer 100. Such a printing system 10 can ensure acquisition of the colorimetry result in a state where the color material is stabilized.

The printing system 10 can calculate an estimated time until stabilization of the color material of the printed product 400 is completed from the amount of change (rate of change) in the color of the measurement patches 301, 505, and 601 (FIGS. 3, 6, and 8) per unit time, and display the estimated time on the display device. Hereinafter, with reference to FIG. 9, a description will be given of an operation of calculating an estimated time and causing the display device to display the estimated time. FIG. 9 is an explanatory diagram of a method of predicting a stabilization completion time of a color material (ink). Here, the measurement patch 301 shown in FIG. 3 will be described as an example.

For example, the colorimetry controller 211 of the colorimeter 200 periodically measures the color of the measurement patch 301 (FIG. 3) and stores the actual measurement value 701 of the amount of color change calculated from the colorimetry result and the previous colorimetry result in the storage part 208. After the plurality of times of color measurement, the colorimetry controller 211 of the color measuring device 200 calculates an approximate curve 702 representing a color change rate (an amount of change per unit time in the actual measurement value shown in FIG. 9) from the actual measurement value 701 of the amount of change stored in the storage part 208. Then, the colorimetry controller 211 of the colorimeter 200 calculates the time in which the change rate of the color is equal to or less than the predetermined threshold value 703 from the approximate curve 702 and the predetermined threshold value 703 set in advance. The colorimetry controller 211 of the colorimeter 200 calculates a remaining time until the stabilization of the color material is completed from the calculation result and the elapsed time from the colorimetry on the first measurement patch, and displays the remaining time on the display operation part 207. That is, the colorimetry controller 211 of the colorimeter 200 causes the colorimetry part 203 to periodically measure the color of the measurement patch 301 and records the amount of change in the color of the measurement patch 301. Then, the colorimetry controller 211 of the colorimeter 200 calculates a predicted time until the stabilization of the color material is completed from the recorded change rate of the color of the measurement patch 301 (the amount of the change per unit time in the actual measurement value 701 shown in FIG. 9), and causes the display device to display the predicted time. As a result, the printing system 10 notifies the user of the remaining time until the stabilization of the color material.

### <Main Features of Printing System and the Like>

The printing system 10 according to the present embodiment can be configured to have the following features.

(1) As shown in FIG. 2, the printing system 10 according to the present embodiment includes a printer 100 that prints an arbitrary printed product 400 on a printing medium, and a colorimeter 200 that measures a color of the printed product 400. The printer 100 includes a printing part 103, and a printing controller 110 that causes the printing part 103 to print, based on information on the printed product 400, the printed product 400 and the measurement patch 301 (FIG. 3) to be used for measurement of the stabilization of color materials of the printed product 400, on a printing medium. The colorimeter 200 includes a colorimetry part 203 and a colorimetry controller 211 that causes the colorimetry part 203 to measure the color of the measurement patch 301 and determines, based on an amount of change in the color of the measurement patch 301, whether the color material (ink) of the printed product 400 has been stabilized.

The printing system 10 according to the present embodiment causes the printing part 103 to print the measurement patch 301 and the printed product 400 on the printing medium based on the information on the printed product 400. The printing system 10 then measures the color of the measurement patch 301 and determines, based on the amount of change in the color of the measurement patch 301, whether the color material of the printed product 400 has been stabilized. Thus, the printing system 10 can determine in a short time whether the color material of the printed product 400 has been stabilized without being affected by the difference in the printing content or the printing conditions. The printing system 10 according to the present embodiment can reduce the waiting time for the stabilization of the color material.

(2) In the printing system 10 according to the present embodiment, the printing controller 110 causes the printing part 103 to print the measurement patch 301 on the printing medium with the same adhesion amount as the maximum amount of color material adhesion within the same printed product 400.

The printing system 10 according to the present embodiment causes the measurement patch 301 to be printed on the printing medium with the same adhesion amount as the maximum amount of color material adhesion in an actual print job. Then, the printing system 10 confirms the stabilization of the color development of the entire printed product 400 by confirming the stabilization of the color development of the measurement patch 301. Thus, the printing system 10 can determine in a short time whether the color material of the printed product 400 has been stabilized without being affected by the difference in the printing content or the printing conditions. The printing system 10 according to the present embodiment can reduce the waiting time for the stabilization of the color material.

(3) As shown in FIG. 4B, in the printing system 10 according to the present embodiment, the colorimetry controller 211 determines whether or not the color material of the printed product 400 is stabilized based on the amount of change in the color of the measurement patch 301.

If the colorimetry controller determines that the color material of the printed product 400 has been stabilized (step S340), the colorimetry controller 211 causes the colorimetry part 203 to start colorimetry on the printed product 400 (step S345).

The printing system 10 according to the present embodiment can obtain accurate colorimetric values of the printed product 400 in a short waiting time by starting colorimetry on the printed product 400 if it is determined that the color materials of the printed product 400 have been stabilized.

(4) As shown in FIG. 4B, in the printing system 10 according to the present embodiment, the colorimetry controller 211 causes the colorimetry part 203 to periodically perform colorimetry on the measurement patch 301. Then, the colorimetry controller 211 determines whether or not the amount of change in the color of the measurement patch 301 is within the predetermined threshold value 703 (FIG. 5) set in advance (step S335). Thus, the colorimetry controller 211 determines whether the color material of the printed product 400 has been stabilized.

The printing system 10 according to the present embodiment can determine whether the color material has been stabilized by determining whether the amount of change in the color of the measurement patch 301 is within the predetermined threshold value 703 (FIG. 5) set in advance.

(5) The printing system 10 according to the present embodiment further includes a display device (not shown) that displays information. The printing controller 110 or the colorimetry controller 211 causes the display device to display a threshold setting screen (not shown) for setting the predetermined threshold value 703 (FIG. 5) to be used as a criterion for determining the stabilization of the color material of the printed product 400. The display device is, for example, the display operation part 107 or the display operation part 207.

The printing system 10 according to the present embodiment can allow the user to set the predetermined threshold value 703 (FIG. 5) by displaying the threshold setting screen on the display device.

(6) As shown in FIG. 5, in the printing system 10 according to the present embodiment, the colorimetry controller 211 determines whether or not the color material of the printed product 400 is stabilized.

At this time, if a UV curable color material is used as the color material, the colorimetry controller 211 determines whether or not the amount of change in the yellow components of the color material in the measurement coordinate space of the color of the measurement patch 301 is within the predetermined threshold value 703 (FIG. 5) set in advance (step S335 in FIG. 4B).

The printing system 10 according to the present embodiment can determine whether the color material has been stabilized by determining whether the amount of change in the yellow component of the color material in the measurement coordinate space of the color of the measurement patch 301 is within the predetermined threshold value 703 (FIG. 5).

(7) As shown in FIG. 6, in the printing system 10 according to the present embodiment, the printing controller 110 causes the printing part 103 to print the measurement patch 301 on the printing medium with the same adhesion amount as the maximum amount of color material adhesion among a plurality of specific colorimetry points set for the printed product 400.

The printing system 10 according to the present embodiment causes the measurement patch 301 to be printed on the printing medium with the same adhesion amount as the maximum amount of color material adhesion in an actual print job. Thus, the printing system 10 can determine in a short time whether the color material of the printed product 400 has been stabilized without being affected by the difference in the printing content or the printing conditions. The printing system 10 according to the present embodiment can reduce the waiting time for the stabilization of the color material.

(8) As shown in FIG. 7, in the printing system 10 according to the present embodiment, the colorimetry controller 211 causes the colorimetry part 203 to perform colorimetry on the measurement patch 301 at the start of colorimetry and at the completion of colorimetry on the printed product 400 (steps S425 and S445). Next, the colorimetry controller 211 determines, based on the amount of change in the color of the measurement patch 301 between the start of the colorimetry and the completion of the colorimetry, whether or not a color variation has occurred during the colorimetry on the measurement patch 301 (step S460). If a color change occurs, the colorimetry controller 211 discards the colorimetry result of the measurement patch 301 (step S465).

The printing system 10 according to the present embodiment determines whether or not a change in color has occurred during the colorimetry on the measurement patch 301 based on the amount of change in color of the measurement patch 301 between the start of colorimetry and the completion of colorimetry. Then, if a color change occurs, the colorimetry controller 211 discards the colorimetry result of the measurement patch 301. The printing system 10 according to the present embodiment can guarantee the acquisition of the colorimetry result in a state where the color material is stabilized.

(9) In the printing system 10 according to the present embodiment, the colorimetry controller 211 temporarily stops the colorimetry on the measurement patch 301 if it is determined that the color material of the printed product 400 is not stabilized based on the change amount of the color of the measurement patch 301.

Such a printing system 10 according to the present embodiment can avoid that the colorimetry on the measurement patch 301 is repeated for more than an arbitrary time.

(10) The printing system 10 according to the present embodiment further includes a display device (not shown) that displays information. The colorimetry controller 211 causes the colorimetry part 203 to periodically measure the color of the measurement patch 301, and periodically acquires the amount of change in the color of the measurement patch 301. If the colorimetry controller 211 determines that the color material of the printed product 400 is not stabilized based on the amount of change in the color of the measurement patch 301, the printing controller 110 or the colorimetry controller 211 causes the display device to display a warning message indicating that the color is not stabilized. The display device is, for example, the display operation part 107 or the display operation part 207.

The printing system 10 according to the present embodiment can notify the user of the warning message indicating that the color is not stabilized.

(11) In the printing system 10 according to the present embodiment, the colorimetry controller 211 causes the colorimetry part 203 to periodically perform colorimetry on the measurement patch 301, and records the amount of change in the color of the measurement patch 301. Then, the colorimetry controller 211 calculates an estimated time until the stabilization of the color material is completed from the recorded change rate of the color of the measurement patch 301 (the amount of change per unit time in the actual measurement value 701 shown in FIG. 9), and displays the estimated time on the display device.

The printing system 10 according to the present embodiment as described above can notify the user of the remaining time until the stabilization of the color material.

(12) As shown in FIG. 2, the printer 100 according to the present embodiment includes a printing part 103 and a printing controller 110. The printing controller 110 causes the printing part 103 to print, on a printing medium, the printed product 400 and the measurement patch 301 to be used for measurement of the stabilization of the color material of the printed product 400, based on the information on the printed product 400. At that time, the printing controller 110 causes the measurement patch 301 to be printed on the printing medium with the same adhesion amount as the maximum amount of color material adhesion within the same printed product 400.

The printer 100 according to the present embodiment prints the measurement patch 301 on the printing medium with the same adhesion amount as the maximum amount of color material adhesion in an actual print job. Thus, the printer 100 can provide the user with the printing medium on which the measurement patch 301 capable of determining whether the color material has been stabilized is printed without being affected by the difference in the print content or the printing conditions.

(13) As shown in FIG. 2, the colorimeter 200 according to the present embodiment includes the colorimetry part 203 and the colorimetry controller 211. The colorimetry controller 211 causes the colorimetry part 203 to perform colorimetry on the measurement patch 301 printed on the printing medium and the arbitrary printed product 400. Next, the colorimetry controller 211 determines, based on the amount of change in the color of the measurement patch 301, whether the color material of the printed product 400 has been stabilized.

The colorimeter 200 according to the present embodiment as described above can determine, based on the amount of change in the color of the measurement patch 301, whether the color material of the printed product 400 has been stabilized.

(14) A color material stabilization determination method according to the present embodiment includes a printing process (step S120, S130 in FIG. 4A) and a determination process (steps S325 to S340 in 4B in FIG. 4A). The printing process is a process of printing the printed product 400 and the measurement patch 301 used for measuring the stabilization of the color material of the printed product 400 on the printing medium based on the information on the printed product 400 by the printer 100 that prints an arbitrary printed product 400 on the printing medium. The determination process is a process of measuring the color of the measurement patch 301 by the colorimeter 200 that measures the color of the printed product 400, and determining, based on the amount of change in the color of the measurement patch 301, whether the color material of the printed product 400 has been stabilized.

In such a color material stabilization determination method according to the present embodiment, in the printing process, the printing part 103 is caused to print the measurement patch 301 and the printed product 400 on the printing medium based on the information on the printed product 400. In the color material stabilization determination method, by measuring the color of the measurement patch 301 in the determination process, it is possible to obtain an accurate colorimetric value of the measurement patch 301 in the shortest waiting time regardless of a difference in color stabilization time due to a difference in printing content or printing conditions. Such a color material stabilization determination method according to the present embodiment can shorten the waiting time for the stabilization of the color material.

(15) The program 802a according to the present embodiment shown in FIG. 1 is a program for realizing the printer 100 used in the printing system 10. The program 802a causes the controller of the printer 100 that prints the arbitrary printed product 400 on the print medium to cause the printing part 103 to print the measurement patch 301 used to measure the stabilization of the color material of the printed product 400 and the printed product 400 on the print medium based on the information on the printed product 400. At that time, the program 802a causes the controller to cause the printing part 103 to print the measurement patch 301 on the print medium with the same adhesion amount as the maximum amount of color material adhesion in the printed product 400.

The program 802a according to the present embodiment can realize the printer 100 used in the printing system 10.

(16) The program 802b according to the present embodiment shown in FIG. 1 is a program for realizing the colorimeter 200 used in the printing system 10. The program 802b causes the controller of the colorimeter 200 that performs colorimetry on the printed product 400 to cause the colorimetry part 203 to perform colorimetry on the measurement patch 301 printed on the print medium together with the printed product 400. The program 802b then causes the controller to determine, based on the amount of change in the color of the measurement patch 301, whether the color material of the printed product 400 has been stabilized.

Such a program 802b according to the present embodiment can realize the colorimeter 200 used in the printing system 10.

Although embodiments of the present invention have been described and illustrated in detail, the disclosed embodiments are made for purposes of illustration and example only and not limitation. The scope of the present invention should be interpreted by terms of the appended claims.

What is claimed is:

1. A printing system comprising:
a printer that prints an arbitrary printed product on a printing medium; and
a colorimeter that measures a color of the printed product, wherein
the printer includes:
a printing part, and
a printing controller that causes the printing part to print, based on information on the printed product, the printed product and a measurement patch to be used for measurement of stabilization of a color material of the printed product on the printing medium, and
the colorimeter includes:
a colorimetry part, and
a colorimetry controller that causes the colorimetry part to measure a color of the measurement patch, and determines, based on an amount of change in the color of the measurement patch, whether the color material of the printed product has been stabilized.

2. The printing system according to claim 1, wherein
the printing controller causes the printing part to print the measurement patch on the printing medium with a same adhesion amount as a maximum amount of color material adhesion within the printed product.

3. The printing system according to claim 1, wherein
upon determining that the color material of the printed product has been stabilized, the colorimetry controller causes the colorimetry part to start colorimetry on the printed product.

4. The printing system according to claim 1, wherein
the colorimetry controller causes the colorimetry part to periodically perform colorimetry on the measurement patch,
the colorimetry controller determines whether or not the amount of change in the color of the measurement patch is within a predetermined threshold value, and
the colorimetry controller determines whether the color material of the printed product has been stabilized.

5. The printing system according to claim 1, further comprising
a display device that displays information; wherein
the printing controller or the colorimetry controller causes the display device to display a threshold setting screen for setting a predetermined threshold value for determining the stabilization of the color material of the printed product.

6. The printing system according to claim 1, wherein
in case of using a UV curable color material as the color material, the colorimetry controller determines whether or not an amount of change in an yellow component of the color material in a measurement coordinate space of the color of the measurement patch is within the predetermined threshold value, and
the colorimetry controller determines whether or not the color material of the printed product is stabilized.

7. The printing system according to claim 1, wherein
the printing controller causes the printing part to print the measurement patch on the printing medium with a same adhesion amount as a maximum amount of color material adhesion among a plurality of specific colorimetry points set for the printed product.

8. The printing system according to claim 1, wherein
the colorimetry controller causes the colorimetry part to perform colorimetry on the measurement patch at a start of colorimetry and at a completion of colorimetry on the printed product,
the colorimetry controller determines, based on the amount of change in the color of the measurement patch between the start of the colorimetry and the completion of the colorimetry, whether or not a color change has occurred during the colorimetry on the measurement patch, and
upon determining that the color change has occurred, the colorimetry controller discards a colorimetry result of the measurement patch.

9. The printing system according to claim 1, wherein
the colorimetry controller temporarily stops colorimetry on the measurement patch upon determining that the color material of the printed product is not stabilized based on the change amount of the color of the measurement patch.

10. The printing system according to claim 1, further comprising:
A display device that displays information, wherein
the colorimetry controller causes the colorimetry part to periodically measure the color of the measurement patch, and periodically acquires the amount of change in the color of the measurement patch, and
in response to the colorimetry controller determining that the color material of the printed product is not stabilized based on the amount of change in the color of the measurement patch, the printing controller or the colorimetry controller causes the display device to display a warning message indicating that the color is not stabilized.

11. The printing system according to claim 1, further comprising:
A display device that displays information, wherein
the colorimetry controller causes the colorimetry part to periodically perform colorimetry on the measurement patch, and records the amount of change in the color of the measurement patch, and
the colorimetry controller calculates an estimated time until the stabilization of the color material is completed from a recorded change rate of the color of the measurement patch, and displays the estimated time on the display device.

12. A printer comprising:
a printing part; and
a printing controller, wherein
in case of causing the printing part to print, on a printing medium, the printed product and a measurement patch to be used for measurement of stabilization of a color material of a printed product, based on information on the printed product, the printing controller causes the measurement patch to be printed on the printing medium with a same adhesion amount as a maximum amount of color material adhesion within the printed product.

13. A colorimetry controller comprising:
a colorimetry part; and
a colorimetry controller wherein the colorimetry controller causes the colorimetry part to perform colorimetry on a measurement patch printed on a printing medium and an arbitrary printed product, and
the colorimetry controller determines, based on an amount of change in a color of the measurement patch, whether a color material of the printed product has been stabilized.

14. A color material stabilization determination method comprising:
a printing process, and
a determination process, wherein
the printing process is a process of printing the printed product and a measurement patch used for measuring stabilization of a color material of a printed product on a printing medium based on information on the printed product by a printer that prints an arbitrary printed product on the printing medium, and
the determination process is a process of measuring a color of the measurement patch by a colorimeter that measures a color of the printed product, and determining, based on an amount of change in the color of the measurement patch, whether the color material of the printed product has been stabilized.

15. A non-transitory computer-readable recording medium storing a program for causing a controller of a printer that prints an arbitrary printed product on a print medium to execute:
causing a printing part of the printer to print the printed product and a measurement patch used to measure stabilization of a color material of a printed product on the print medium based on information on the printed product, and
causing the controller to cause the printing part to print the measurement patch on the print medium with a same adhesion amount as a maximum amount of color material adhesion within the printed product.

16. A non-transitory computer-readable recording medium storing a program for causing a controller of a colorimeter that performs colorimetry on a printed product to execute:
causing a colorimetry part of the colorimeter to perform colorimetry on a measurement patch printed on a print medium together with a printed product, and
causing the controller to determine, based on an amount of change in a color of the measurement patch, whether a color material of the printed product has been stabilized.
